(19) United States
(12) Patent Application Publication
(10) Pub. No.: US 2012/0188451 A1
(43) Pub. Date: Jul. 26, 2012

(54) Child's Sleep Assistant Toy

(76) Inventors: Martyn Schmidt, Mount Prospect, IL (US); Andrew Schmidt, Mount Prospect, IL (US)

(21) Appl. No.: 13/355,628

(22) Filed: Jan. 23, 2012

Related U.S. Application Data
(60) Provisional application No. 61/436,434, filed on Jan. 26, 2011.

(51) Int. Cl. H04N 9/31; H04N 5/63; H04N 5/44; H04N 5/60

(52) U.S. Cl. 348/553; 348/738; 348/730; 348/E09.025; 348/E05.122; 348/E05.127; 348/E05.099

(57) ABSTRACT

A child's sleep assistant device is provided for assisting a child with falling asleep by playing calming images and soothing sounds. The device comprises a main body, a projection assembly, an audio assembly, a translucent dome and a power source. The projection assembly, audio assembly and power source are housed within the main body, which is covered by the translucent dome. Animated scenes are projected by a digital projector onto the wall or ceiling of a child's bedroom. Corresponding audio may be played that corresponds to the animated scenes, or soothing music or bedtime stories. The scenes may be changeable and their size and intensity modified by a parent or caregiver.

### CROSS REFERENCE TO RELATED APPLICATION

This application claims the benefit of U.S. Provisional Application No. 61/436,434 filed on Jan. 26, 2011 entitled “Sweet Dreamer.”

### BACKGROUND OF THE INVENTION

1. Field of the Invention

The present invention relates to a child's toy. More specifically to a child's sleep assistant device for facilitating the sleep of a child by playing soothing visual images and sounds.

Children often have difficulty falling asleep due to their tendency to be easily excited. They are always “on the go” and can find it difficult to relax at bedtime. Much to the chagrin of parents around the world, children can lay awake in bed for hours without falling asleep. This can be highly frustrating to parents and caregivers who must constantly check on the child, or put the child back to bed after he or she has gotten up. Parents often try to soothe sleepless children through the use of songs and bedtime stories. If a child is particularly excited or restless, the process of storytelling and singing may have to be repeated multiple times over the course of an evening. Some parents resort to playing soothing music or videos for children in an effort to lull the child to sleep. Such means risk providing too much stimuli for a child, thereby keeping him or her awake. Alternatively, the music or video may end before the child falls asleep and without the parent being aware that the soothing sounds and images have stopped. Over time, the sleeplessness of a child can lead to significant loss of much needed sleep by the parents. A device is needed that provides continuous soothing images and sounds to a child to facilitate the child falling asleep.

2. Description of the Prior Art

The prior art contains a variety of child sleep assistant devices for providing projections of comforting images on the bedroom walls of a child. These devices have familiar design and structural elements for the purposes of displaying static images; however they are not adapted for the task of projecting moving scenes.

Feliciano, U.S. Pat. No. 7,329,035 discloses a wearable child's flashlight toy comprising an outer casing having oblate ends and a tapered mid-section, a battery source, a power switch, a first and second light source, and a projection means. Said projection means comprises a translucent lens having images disposed upon it. A lightbulb is secured behind the translucent lens portion and is operatively connected to the battery source. The battery source is operatively connected to the power switch. A child may turn the flashlight on and shine it at a flat surface to project images upon the flat surface. An elastic band is secured to the device to allow the same to be removably attached to the forearm of a child. Feliciano does not disclose a device for projecting moving scenes. Feliciano also does not disclose a freestanding embodiment.

Sutton, U.S. Pat. No. 5,517,264 discloses a wall-mounted nightlight. The night-light is shaped like a television and has a translucent front panel with a light source seated behind the panel. The light source is operatively connected to light socket prongs, which also act as a mounting means for the device. When the device is turned on the light source illuminates a sheet of film placed between the light source and the translucent panel. The images on the film are then projected onto a wall or ceiling. Sutton is similarly not adapted to display moving scenes. A freestanding embodiment of the device is also not contemplated by Sutton.

McCann, U.S. Pat. No. 7,438,446 discloses a night-light having an outer casing having a foldable top, a projector, light source, and power assembly. The outer casing has a lid that is hingedly secured to a lower portion of the casing. A projector is secured to an interior surface said lid. The projector is operably connected to a power source comprising wall plugs for an electric socket. When the projector is turned on, still images are projected onto a wall or ceiling. Alternatively the projector may be turned off but the light source may be used as a night-light. To store the device, the lid is closed and the device is unplugged from the wall. This device does not contemplate a freestanding embodiment. McCann also does not disclose the ability to project moving scenes on a wall or ceiling.

Sedlmayr, U.S. Pat. No. 5,307,051 discloses a sleep assistant device for providing audio and visual output to soothe a sleepless child. The device has an audio sensor for determining whether a predetermined audio level has been reached. If a child cries the audio sensor detects the increase in noise and signals the device to play audio and visual output. Audio output is played through speakers in the device and may consist of a bedtime story or a soothing song. Visual output is created by illuminating a light source that is seated behind a translucent film. The film may have images such as cartoon characters or animals printed on it so that when the light source is illuminated the images are projected on a wall or ceiling. Similar to the aforementioned patents, the Sedlmayr device visual output does not include moving scenes.

The devices disclosed by the prior art do not address the need for providing the visual stimulation resulting from moving images. The current invention relates to a device for playing soothing scenes and sounds on a flat surface in a child's room, while having a decorative border cutout that forms a frame around a projected scene and the use of removable media for installing new scenes to be projected. It substantially diverges in structural elements from the prior art, consequently it is clear that there is a need in the art for an improvement to the child sleep assistant devices In this regard the instant invention substantially fulfills these needs.

### SUMMARY OF THE INVENTION

In view of the foregoing disadvantages inherent in the known types of child sleep assistant devices now present in the prior art, the present invention provides a new projection means wherein the same can be utilized for providing convenience for the user when displaying moving images and scenes on a wall or ceiling of a child's bedroom. The device comprises a main body, a translucent dome, a projector assembly, an audio assembly, and a power source. The main body houses the projector assembly and audio assembly, and is covered by the translucent dome.

The device is freestanding and may be placed on any flat surface in a child's bedroom. A parent may rotate and position the device as necessary to produce projection of images on a desired portion of a wall or ceiling. To facilitate this ease of placement, the power source may be a set of electrical plugs that operatively connect with a wall outlet, or alternatively the power source may be batteries housed within the main body. If the device contains battery power as a primary power source or backup power source, then the placement of the device is not restricted to areas of the child's room that are near power outlets.

When the device is turned on, power flows to the projection assembly and the audio assembly, resulting in a projection of moving images on a wall or ceiling and the generation of auditory output. The projection assembly comprises a digital projector, a light source and a lens. Animated projections created by the digital projector are illuminated by the light source and magnified by the lens so that the resulting scene is displayed on a wall or ceiling at a size easily viewable by a child lying in bed. The diameter of the viewing area may be toggled via an aperture adjustment dial. Alternatively, the diameter of the projected images may be adjusted via buttons or a touch screen interface.

The audio assembly comprises a sound generation means such as a computer soundcard and a speaker. Sounds such as soothing music, rain, aquatic sounds or bedtime stories may be played to assist a child with falling asleep. The sounds may be coordinated with the scenes being displayed by the device or may be selected independent of the visual output. At least one scene and audio track are preloaded onto the device and may be played without any additional installation. Additional scenes and sounds may be installed on the device by removable media such as a disc, flash drive or cartridge. A user may select the desired scene and audio track via buttons or alternatively via a touchscreen interface.

It is therefore an object of the present invention to provide a new and improved child sleep assistant device having all of the advantages of the prior art and none of the disadvantages.

Another object of the present invention is to provide a new and improved child sleep assistant device having a projector means capable of projecting animated scenes on a wall or ceiling of a room.

Yet another object of the present invention is to provide a new and improved child sleep assistant device having audio output means for playing sounds that correspond to an animated scene being projected by the device.

Still another object of the present invention is to provide a new and improved child sleep assistant device adapted to receive removable storage media containing scenes and sounds that can be played on the device.

Another object of the present invention is to provide a new and improved child sleep assistant device having an adjustment means for manipulating the diameter and focus of a projected scene.

A further object of the present invention is to provide a new and improved child sleep assistant device having resilient and durable construction.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above as well as other objects not stated above will become more apparent after a study of the following detailed description thereof. Such description makes use of the annexed drawings wherein like numeral references are utilized throughout.

FIG. 1 shows a perspective drawing of the present child sleep assistant device in use.

FIG. 2 shows a magnified perspective view of the present child sleep assistant device.

### DETAILED DESCRIPTION OF THE INVENTION

Reference is made herein to the attached drawings. Like reference numerals are used throughout the drawings to depict like or similar elements of the child sleep assistant device. For the purposes of presenting a brief and clear description of the present invention, the preferred embodiment will be discussed as used for playing soothing animated scenes and sounds to assist a child with falling asleep. This is for representative purposes only and should not be considered to be limiting in any respect.

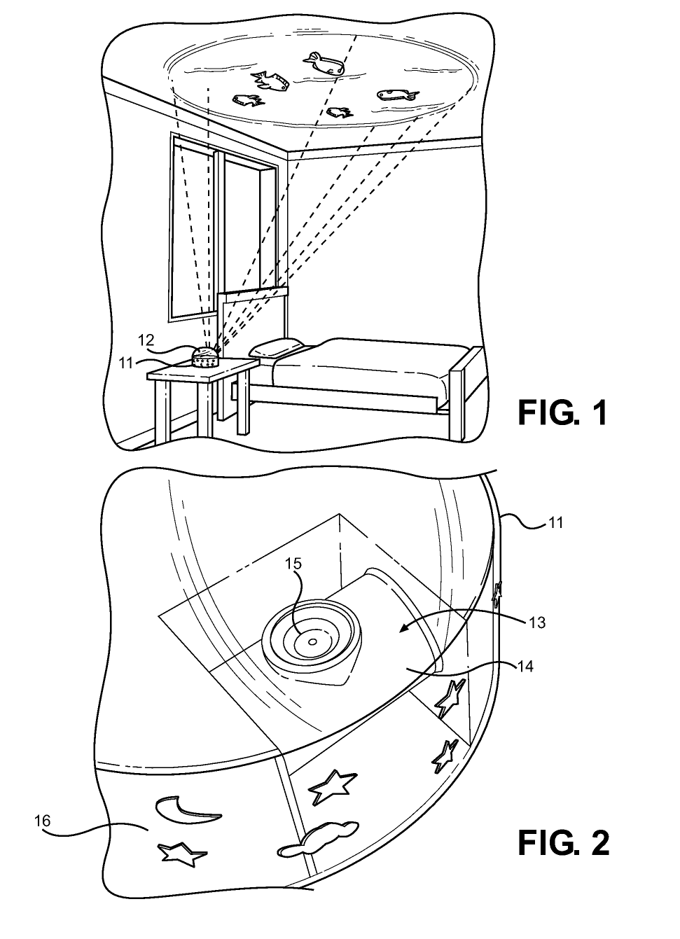

Referring now to FIG. 1 there is shown a view of the child sleep assistant device in use. It has a main body 11 and a translucent dome lid 12. The device sits on a table or similar surface and projects a moving image such as fish on the ceiling of the room. The main body 11 may have a geometrical shape such as a cylinder or cube. Housed within the main body 11 are a projection assembly, an audio assembly and a power source. A decorative border 16 having cutout shapes is disposed along exterior side surfaces of the body (seen in FIG. 2). The cutout shapes may light up when the device is turned on, causing a ring of shapes to be displayed on the walls of the room. Simple geometric shapes such as stars, moons, hearts and the like are preferred for the cutouts. In a similar fashion, a border may be applied to the boundary of the projected image by placing a decorative cutout around the projection lens of the device, causing the projected image to have a specifically designed boundary on the wall or ceiling surface.

A translucent dome is secured to the top of the main body. The dome protects the projection and audio assemblies from dust and debris that could result in malfunction of the device. Because the dome is translucent, light from the projection assembly passes through easily, thus the dome does not significantly distort projected images. The dome also makes the device easy for a user to maintain because particulate accumulates on the dome surface where it can be easily wiped away, rather than inside the projection assembly where dust would be hard to reach. High-friction matting may be secured to the bottom surface of the device to reduce slipping that could result if a child jars the flat surface. Alternatively, feet made of high-friction material may be used to reduce slipping. In an alternate embodiment, the dome may be removed to allow direct transmission of the projector image onto a bedroom surface, without interference from the dome.

In a preferred embodiment, the main body 11 houses a power source comprising a power cord having a set of prongs that operatively connect to an electrical wall socket. The power cord may be of the type used in the art for small electronic devices. A secondary power source is housed within the main body and may comprise replaceable batteries. This battery source is activated by a flow control sensor. The sensor detects the stream of current flowing into the device through a power cord and triggers the use of battery power if there is no current flow coming from the primary power source. In an alternative embodiment the power source may comprise battery power without any power cords or pronged wall socket adapters. The ability to use battery power permits the placement of the device anywhere within a child's bedroom because it is not reliant upon a wall socket. Parents can position the device around a child's bedroom according to the desired location of a projected image. In either embodiment, there is a power switch in the form of a button, a slide switch or a rocker switch, located on the outside of the main body. The power switch turns the flow of power off and on and thereby controls activation of the device.

Referring now to FIG. 2, there is shown a magnified view of the projection assembly 13 housed within the main body 11. The projection assembly comprises a digital projector 14, a light source within said projector (not shown), a storage media (not shown), and a lens 15. The projection assembly is operatively connected to the power source so that when power flows to the assembly the light source illuminates, the digital projector activates and a scene is transmitted thereto by the storage media. A scene generated by the projector is then illuminated by the light source and projected through the lens, which magnifies the image so that the resultant projection is easily viewable to a child lying in bed. The display of calm scenes such as aquarium fish, sheep, flowers, the night sky and the like provide a distraction for a child that is not visually stimulating enough to prevent the brain from relaxing and progressing into a sleep state.

The diameter of the projected scene may be modified by a user via a dial disposed on the outside of the main body. Rotation of the dial causes the aperture of the lens to grow or shrink thereby manipulating the size of the projected image. The intensity of the light source may also be toggled via a dial disposed on the outside of the main body. Additionally the projector may be toggled between a fixed position state and a rotating state. When the projector rotates the projected scene also rotates. Rotation of the projector may be toggled by a switch such as a slide switch or a rocker switch, disposed on the outside of the main body. The lens may further have its focus updated by a similar dial, which is necessary for projecting on surfaces at different distances.

The sound assembly comprises a computer soundcard operatively connected to the storage media, and at least one speaker (not shown). Said audio assembly is operatively connected to the power source so that when power flows to the audio assembly, an audio file is transmitted by the storage media to the soundcard, which interprets the audio file, translating it into signals. These signals are then sent to the at least one speaker that plays the signals as audio output. Sounds played by the device may include soothing music, aquatic noises, environmental effects corresponding to the projected scene or bedtime stories. Such sounds may soothe a child and help them relax, thus facilitating the sleep process.

The storage media has a least one moving scene and at least one corresponding audio file stored on the same. Scenes that have general appeal, such as aquarium fish, the night sky, or rainforest scenes, are preferred as default scenes. The default audio file should be environmental noises associated with the default scene. In an alternative embodiment, the device may have means for receiving and reading removable storage media. The removable storage media contains additional scenes and sounds that may be loaded onto the device's permanent storage media, where it may be selected at any time via a selection interface. In another alternative embodiment the scenes and sounds stored on the removable storage media may only be played while the removable media is inserted into the device.

In an alternative embodiment, all modifiable settings may be changed via a digital display and associated selection buttons. The selection buttons may have arrows displayed on their surfaces to indicate the direction a user is cycling through selections. In another alternative embodiment, the modifiable settings of the device may be changed via a touch screen interface. The interfaces of either embodiment are disposed on the main body of the device where selections can easily be made by a parent. The device may also have a sleep timer associated with its operation, wherein the device automatically turns off after a programmed amount of time, allowing the device to shut off after the child is asleep to conserve power, prevent overheating and to allow a quiet and dark room for the child to sleep.

In use an individual places the device on a flat surface in a child's bedroom such as a table, desk or dresser. The device is then turned on and a projection is displayed on the ceiling or wall of the room. Size of the image, sound volume and other settings may be modified via the user according to the preferences of the child. If rotation of the image is desired, the projector may be toggled into a rotating state. The user may then turn off other lights in the room and exit. The calming scenes and soothing sounds generated by the device will assist the child with relaxing and falling asleep.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1. A children's toy for helping a child fall asleep, comprising:
a main body, a power switch and at least one power source;
a storage media;
a projection assembly comprising a digital projector that is capable of projecting animated images and motion pictures, a light source, and a lens, said projection assembly being operatively connected to said power source and said storage media;
an audio assembly comprising a sound card and at least one speaker, said audio assembly being operatively connected to said power source and said storage media;
said projection assembly, said audio assembly, said storage media and said power source are housed within said main body.

2. The device of claim 1, wherein said power source comprises a primary power source being a power cord and prongs adapted to operatively connect with an electrical wall outlet, and a second power source comprising removable batteries.

3. The device of claim 2, wherein said power source further comprises a flow control sensor for monitoring flow of current from said primary power source and activating said second power source if no flow is sensed from said primary power source.

4. The device of claim 1, wherein said power source comprises removable batteries.

5. The device of claim 1, wherein the aperture of said a projection lens of said digital projector may be reduced or increased by a user.

6. The device of claim 1, wherein said digital projector has a fixed mode and a rotating mode that may be toggled by a user.

7. The device of claim 1, wherein said main body has a border of cutouts disposed around an outer surface for projecting light therethrough.

8. The device of claim 1, further comprising an opening in said main body adapted to receive removable storage media and communicate said removable storage media scene files and sound files that may be played by the device while said removable storage media is inserted within said opening.

9. The device of claim 1, further comprising an opening in said main body adapted to receive removable storage media and communicate said removable storage media scene files and audio files that may be transferred to said storage media housed in said main body, for use at any time.

10. The device of claim 1, further comprising:
a digital interface and associated selection buttons for allowing a user to modify device settings and select scenes and audio to be played.

11. The device of claim 1, further comprising:
a touch screen interface for allowing a user to modify device settings and select scenes and audio to be played.

12. A device of claim 1, further comprising a translucent dome secured to an outer edge of a top surface of said main body.

13. A device of claim 1, further comprising a sleep timer that automatically turns off said power after a programmed period of time.

14. A device of claim 1, further comprising a border design around said lens, wherein said projection has a decorative border when projected onto a surface.

15. A children's toy for helping a child fall asleep, comprising:
a main body having a border of cutouts disposed about an outer surface;
a translucent dome secured to an outer edge of a top surface of said main body;
a power switch and at least one power source comprising replaceable batteries;
a storage media having at least one scene file and audio file stored on said storage media;
a projection assembly comprising a digital projector capable of projecting animated images and motion pictures, a light source, and a lens, said projection assembly being operatively connected to said power source and said storage media, and having a fixed state and a rotating state, which may be toggled by a user;
an audio assembly comprising a sound card and at least one speaker, said audio assembly being operatively connected to said power source and said storage media;
said projection assembly, said audio assembly, and said storage media, and said power source are housed within said main body;
an opening in said main body adapted to receive removable storage media, operatively connect said removable storage media with said storage media housed within said main body.

16. The device of claim 15, wherein said removable storage media contains scene files and sound files that may be played by the device while said removable storage media is inserted within said opening.

17. The device of claim 15, wherein said removable storage media contains scene files and audio files that may be transferred to said storage media housed in said main body, for use at any time.

18. The device of claim 15, further comprising:
a digital interface and associated selection buttons for allowing a user to modify device settings and select scenes and audio to be played.

19. The device of claim 15, further comprising:
a touch screen interface for allowing a user to modify device settings and select scenes and audio to be played.

20. A device of claim 15, further comprising a border design around said lens, wherein said projection has a decorative border when projected onto a surface.
